(19) United States
(12) Patent Application Publication
(10) Pub. No.: US 2014/0011045 A1
(43) Pub. Date: Jan. 9, 2014

(54) Brazed mechanical components and related methods

(71) Applicant: Aeres Motors, Calistoga, CA (US)

(72) Inventors: David A. Slemp, Calistoga, CA (US); Darren Baurn, Phoenix, AZ (US)

(73) Assignee: Aeres Motors, Calistoga, CA (US)

(21) Appl. No.: 13/986,889

(22) Filed: Jun. 13, 2013

Related U.S. Application Data
(60) Provisional application No. 61/689,927, filed on Jun. 15, 2012.

(51) Int. Cl. B23K 1/00; B32B 15/20; B32B 15/01

(52) U.S. Cl. CPC B23K 1/0008; B32B 15/01; B32B 15/20
USPC 428/613; 123/193.5; 428/615; 428/650; 228/164

(57) ABSTRACT

Power generation and transmission components and methods of manufacture are described in which a component is custom designed and produced in discrete layers using computer numerical controlled machining. The design is separated into layers, and the layers are individually machined to impart design features. The layers are then prepared for, and undergo a brazing process in order to build a functionally unitary mechanical component. Components according to the invention include, but are not limited to, engine blocks, cylinder heads, transmission housings, centrifugal pump housings, cylinder blocks, monoblocs (engines in which the cylinder block and cylinder head are formed as one unit), engine crank cases, automotive power train housings and many other large unit or unitary structure components. A commercial method of producing custom components is also described.

### DOMESTIC PRIORITY

This application claims the benefit of the priority date of provisional U.S. Patent Application No. 61/689,927, filed Jun. 15, 2012, by David A. Slemp and Darren Baum, titled BRAZED MECHANICAL COMPONENTS AND RELATED METHODS. This application incorporates U.S. Patent Application No. 61/689,927 in its entirety.

### FIELD OF THE INVENTION

The present invention relates generally to the field of mechanical power generation and transmission components including internal combustion engine components, a method of manufacture of components, and a method for commercially producing prototype, designed-to-order, and built-to-order components.

### BACKGROUND

Large mechanical power generation and transmission components including internal combustion engine components often must withstand extremely high pressures and temperatures during normal operation. More specifically, engine blocks, cylinder heads, transmission housings, centrifugal pump housings, cylinder blocks, monoblocs (engines in which the cylinder block and cylinder head are formed as one unit), crank cases, automotive power transmission components and many other large unit or unitary structure components are examples of such components. Many of these components, including cylinder heads and blocks, also commonly require a structure having ports and internal passages that form fluid distribution systems including cooling systems for dissipating the heat generated by internal combustion, as well as high pressure oil supply passages for component lubrication and low pressure oil return passages. Large engine and power transmission components are commonly produced using metal casting techniques. Metal casting is a fine choice for large quantity or high volume production of, for example, engine blocks and cylinder heads incorporating complex design. However, metal casting requires significant up-front costs including tooling (pattern design, core design) and prototype, costs which increase exponentially with increased size and complexity of components. Therefore, especially for large and complex components, metal casting may be economical only for relatively high volume production. It may also inhibit design enhancement, rendering it uneconomical for custom engines.

In addition to the drawback of high per part investment cost, the resulting inner surfaces of cast components may have medium to poor finishes. Medium to poor finishes may be suitable for medium tolerance, high volume production. But high performance engines, or engines otherwise characterized as “high end” market, require higher quality finishes and greater precision. Consequently, metal casting may be a poor method for manufacture of these high end market engine components.

As an alternative to metal cast manufacturing, “single billet” Computer Assisted Design and Computer Assisted Machining (CAD/CAM) methods may be cost-effective for prototype work and for low to medium volume production. Tool accessible surfaces produced using single billet methods typically have greater feature and surface accuracy than cast components, and the material quality can be much higher. However, inner chambers are nearly impossible to create using single billet methods. Further, blind voids are impossible to create, rendering single billet methods practical only for producing cylinder heads or components that do not require an internal liquid cooling system (such as, for example, those used with some drag racing engines).

Turning now to the art of computer numerical controlled (CNC) machining, which has emerged as a method by which much modern day machining is carried out, it can be considered superior to other methods of design and manufacture in many respects. CNC machining generally refers to the highly automated process which incorporates computer assisted design (CAD) and computer assisted machining (CAM). When comparing CNC machining with the various techniques mentioned above, it allows for the highest precision, the greatest design freedom, the quickest part fabrication, and the least waste. In addition, it is cost-effective for small quantity, high quality components.

Computer numerical controlled machining would be superior to metal casting and other methods for prototype, custom, or boutique engine components in low volume, niche markets. However, CNC machining cannot be used, for example, to fabricate parts with blind or otherwise inaccessible inner voids, such as passages within cylinder heads. Consequently, CNC machining alone cannot be used to produce the most common type of cylinder head, and costly metal casting remains the method of choice for manufacture. There remains a need for an economical method of custom design and production of high quality, high accuracy, complex engine components using CNC tooling.

According to the invention, the advantages of CNC machining are optimized as a preliminary step in the custom design of mechanical power generation and transmission components including, but not limited to, pump casings, engine cylinder heads, and engine blocks. Precision and complexity may be incorporated into the custom design. Following the custom design of a complex component, parting lines, typically horizontal, are then added to the design, essentially to divide the design into “layers”. Once the design is divided into layers, it can then be machined from blank metal plates. The blank metal plates are commonly available as a commodity in the industry and can be ordered or maintained in inventory, and readily utilized. After the design is machined from the separate blank plates, the plates can be stacked and joined via brazing to form a unitary component. The methods can be used to produce cylinder heads, cylinder blocks, pump casings, transmission housings, engine blocks, monoblocs, crank cases, any automotive power train housing that is conventionally made by casting metal, and many other unitary engine components.

As the most desirable method for joining the stacked plates, we turn now to the art of brazing; a basic method of joining metals that is discussed in depth in the industry literature. It can be characterized briefly as joining one or more close fitting “base” metal parts using a second metal and heat. Brazing is performed by placing a “filler” metal between the base metal parts, heating the filler metal to its liquidus temperature, and allowing it to flow by capillary action over the base metal part(s). Examples of brazing methods include Gas Furnace Brazing, Induction Brazing, Dip Brazing, Block Brazing, Diffusion Brazing, Electron Beam Brazing, Exothermic Brazing, Flow Brazing, Infrared Brazing, Laser Brazing, Step Brazing, Twin Carbon Arc Brazing, Torch Brazing, and Vacuum Furnace Brazing. Upon cooling, the parts essentially form a unitary piece. The base metal and the filler material are both carefully selected for desired properties depending upon the particular application. In many base/filler combinations, the joint formed by brazing is essentially as strong as, or stronger than the base metal itself. Brazing is typically used to reliably repair cracks, or to join finished components of engines such as liners, faces, grounding strips, counterbalance members, valve seats, etc. It is also used to join metal parts for good physical and thermal contact, and to join dissimilar metals and/or single features that are not readily incorporated using metal casting techniques. According to the invention, however, it is used as a principle step to build a high precision, maximum tolerance, and unitary components.

According to the invention, a commercial method of manufacture of a unitary, maximum tolerance engine component incorporates the advantages of CNC machining and brazing. Utilizing the invention, custom, low-volume, prototype, high-efficiency or other niche market high performance engine components can be designed and built to order. The design requirements are provided by a customer, and incorporated into a design. Parting lines are incorporated into the design in order to expose all blind voids and passages to CNC tooling. The design is then machined onto separate blank metal plates. The machined plates are stacked and brazed together to build a custom engine component. Finished components may be lighter weight, more robust, more efficient, require less maintenance, and be more aesthetically pleasing than conventional cylinder heads. They can be designed and built with exceptional precision, near perfect tolerances and alignments. Such a method is cost effective for low volume production and can incorporate custom designs having a very high level of internal complexity.

### BRIEF DESCRIPTION OF THE DRAWINGS

FIG. 1 is a perspective frontal view of an embodiment of a complete cylinder head according to the invention.

FIG. 2 is a perspective plan view of the back side of the embodiment of FIG. 1.

FIG. 2A is an “exploded” view of FIG. 2, rotated slightly to the left, revealing the layers of the embodiment of FIG. 1, which are further illustrated in FIGS. 3-6.

FIG. 3 is the view of FIG. 2 minus the deck plate (or minus a first layer) in order to expose a subsequent layer and its brazing surfaces.

FIG. 4 is the view of FIG. 3 minus the first port layer (which represents a second layer) in order to expose a subsequent layer and its brazing surfaces.

FIG. 5 is the view of FIG. 4 minus the second port layer (which represents a third layer) in order to expose a subsequent layer and its brazing surfaces.

FIG. 6 is the view of FIG. 5 minus the cam journal layer (which represents a fourth layer) in order to expose a fifth and final layer and its brazing surfaces.

FIG. 7 is a perspective view of an embodiment of an engine block according to the invention.

FIG. 8 is an “exploded” view of the embodiment of FIG. 7.

FIG. 9 is a perspective view of an embodiment of a centrifugal pump housing according to the invention.

FIG. 10 is an “exploded” view of the embodiment of FIG. 9.

### DETAILED DESCRIPTION

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be routine undertaking for those of ordinary skill in the art having the benefit of this disclosure. The system and methods disclosed herein boast a variety of inventive features and components that warrant patent protection, both individually and in combination.

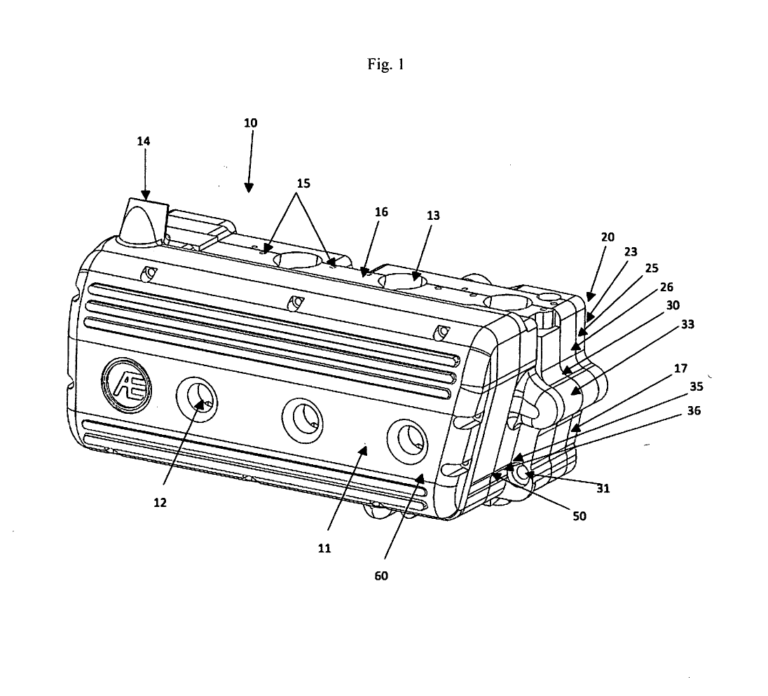

Referring to FIG. 1, the characteristics of an engine component manufactured according to the invention can be described. Finished cylinder head 10 is seen from a perspective frontal view. Visible in FIG. 1 are finished cylinder head 10 and its front 11, top 16, and right side 17. Cylinder head 10, generally speaking, includes most all of the components of a conventional cylinder head. These components include, for example, spark plug access holes 12, intake manifold ports 13, cam position sensor mount 14, intake manifold bolt holes 15, and clearance hole for cylinder head bolt 31.

Finished cylinder head 10, according to the invention, also includes several brazing joint lines and several “layers”, each visible along right side 17. It should be noted that in a finished engine component according to the invention, brazing joint lines were preceded by “parting lines” designed into the component during a process according to the invention. Accordingly, the terms “parting lines” and “brazing joint lines” may be used interchangeably herein, though it is understood that these features are parting lines at one point in the process, and are brazing joint lines at another point in the process. Parting lines may be horizontal or vertical or oriented at any angle, even in the same assembly. (In fact, in alternative embodiments, parting lines may in effect create a three-dimensional puzzle assembly in which the individually machined parts are shaped to lock the assembly together prior to brazing.) However, in many designs, horizontal lines may be advantageous for stacking, clamping, alignment or other assembly of machined plates or blocks prior to the brazing heat cycle, and may therefore be preferable.) Specifically, illustrated in FIG. 1, along right side 17 and proceeding from back to front 11, is a first layer known as deck plate 20. First brazed joint 23 connects deck plate 20 to first port layer 25. Similarly, second brazed joint 26 joins first port layer 25 to second port layer 30. Second port layer 30 is joined, via third brazed joint 33, to first cam journal layer 35. First cam journal layer 35 is attached to second cam journal layer 50 via fourth brazed joint 36. And valve cover 60 is bolted to the second cam journal layer 50. The outer surface of valve cover 60 is seen as front 11. A cylinder head according to the invention may include varying configurations of ports and mounting holes, and/or a greater or lesser number of brazed joints and layers than the embodiment illustrated in FIG. 1, and still be within the scope of the invention.

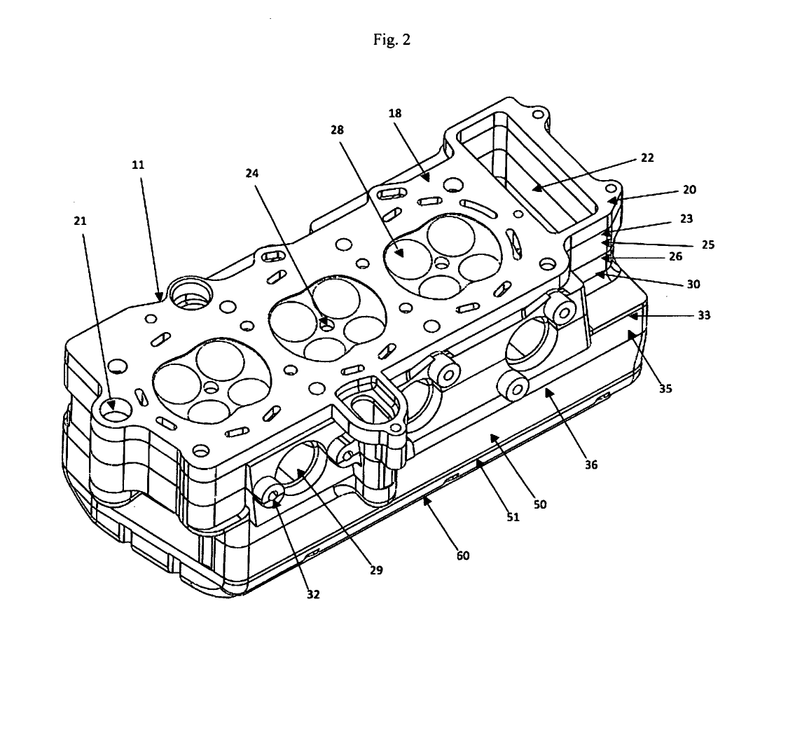

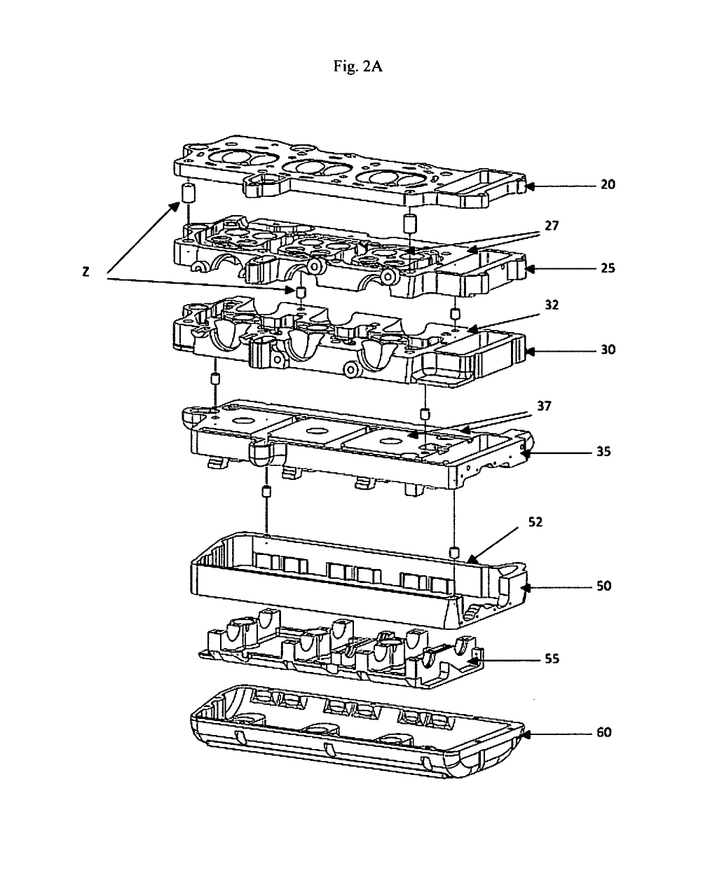

FIG. 2 also illustrates the features of a complete cylinder head 10 according to the invention. In FIG. 2, cylinder head 10 is seen as though rotated 180 degrees from FIG. 1, and then pushed face down onto its front 11. It is consequently viewed from a perspective planar view of the back 18, where features of its back 18 and bottom 19 are most readily visible. Deck plate 20 is now readily visible. Features of deck plate 20 include oil vapor vent 21 at the far left side of the figure, and timing chain access port 22 at the far right. Also visible are numerous ports in communication with the combustion chambers, including spark plug holes 24 and valve ports 28.

In the bottom 19 of cylinder head 10, exhaust manifold ports 29, and exhaust manifold mounting holes 32 are also visible in FIG. 2. While cylinder head 10 can be characterized in general as conventional, a cylinder head according to the invention may be as conventional or as custom as desired by the customer and/or designer. Sizes of ports, thicknesses of walls between passages, and numerous other features may be varied according to the objectives of the design, and still be within the scope of the invention.

As mentioned above, in addition to features of a conventional cylinder head, the design of cylinder head 10 also includes numerous parting lines or in a finished cylinder head, brazing joints. As shown in FIG. 1 and perhaps more readily seen in FIG. 2, cylinder head 10 includes first parting line or first brazing joint 23, second parting line or second brazing joint 26, third parting line or third brazing joint 33, and fourth parting line or fourth brazing joint 36. Fifth parting line 51 represents a joint of bolted components in a finished cylinder head 10. Alternative embodiments may include a greater or lesser number of parting lines and brazing joints. First parting line 23, second parting line 26, and so on through fifth parting line 51 are incorporated into the design at specific intervals, typically at predetermined heights, and are preferably horizontal. Using parting lines 23 et seq., the design of cylinder head 10 is essentially divided into layers of predetermined thicknesses.

For example, first parting line 23 divides cylinder head 10 into a first layer and a second layer, referred to as deck plate 20 and first port layer 25 respectively. Second parting line 26 separates cylinder head 10 into two more layers, namely first port layer 25 and second port layer 30. As illustrated in FIG. 2, the top halves of both the intake and exhaust ports are defined within first port layer 25, and the bottom halves of both the intake and exhaust ports are defined within second port layer 30. Third parting line 33 divides cylinder head 10 between second port layer 30 and cam journal layer 35. Fourth parting line 36 divides cylinder head 10 between first cam journal layer 35 and second cam journal layer 50. Fifth and final parting line 51 in the example of FIG. 2 divides the design of cylinder head 10 between second cam journal layer 50 and valve cover 60. Optional alignment features (not pictured) may facilitate accurate alignment of the separate layers prior to brazing.

FIG. 2A illustrates the embodiment of FIG. 2, rotated approximately 15 degrees clockwise, and exploded so that the many layers making up finished cylinder head 10 of FIG. 2 may be more easily viewed. Specifically, proceeding from the top of the figure, deck plate 20 is above first port layer 25. Port layer 25 includes brazing surfaces 27, as do nearly all of the following layers. During the manufacture of finished cylinder head 10, brazing filler material (not pictured here) will be applied to some or all of brazing surfaces 27 prior to brazing to form brazing joints. Following first port layer 25 is second port layer 30. Second port layer 30 also includes brazing surfaces 32. Beneath second port layer 30 is first cam journal layer 35 having brazing surfaces 37. Second cam journal layer 50, having brazing surfaces 52, is beneath first cam journal layer 35. Cam journal cap 55 is sandwiched between second cam journal layer 50 and valve cover 60.

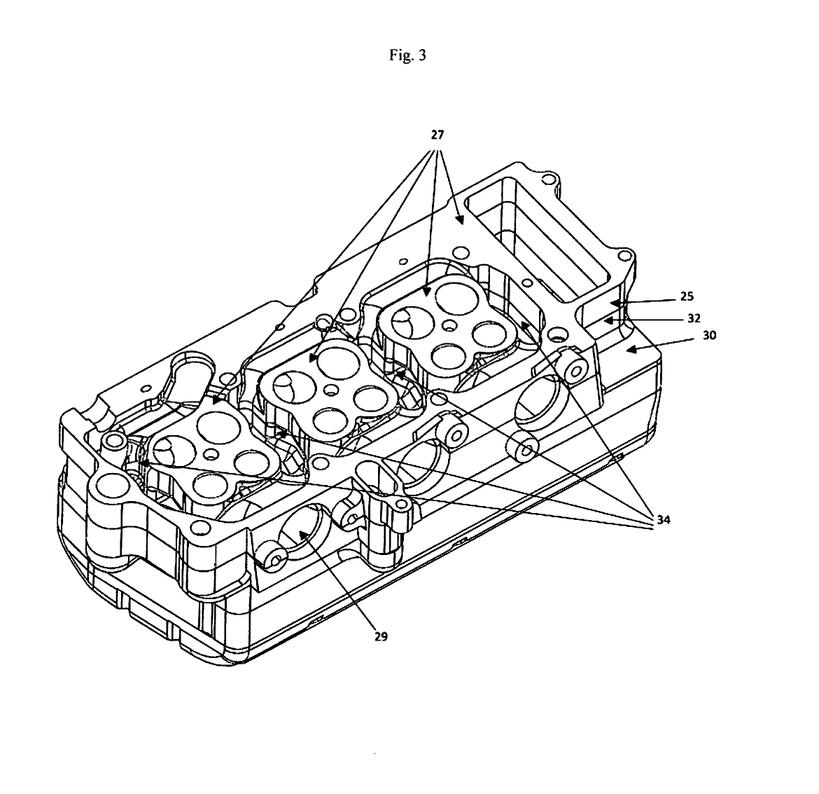

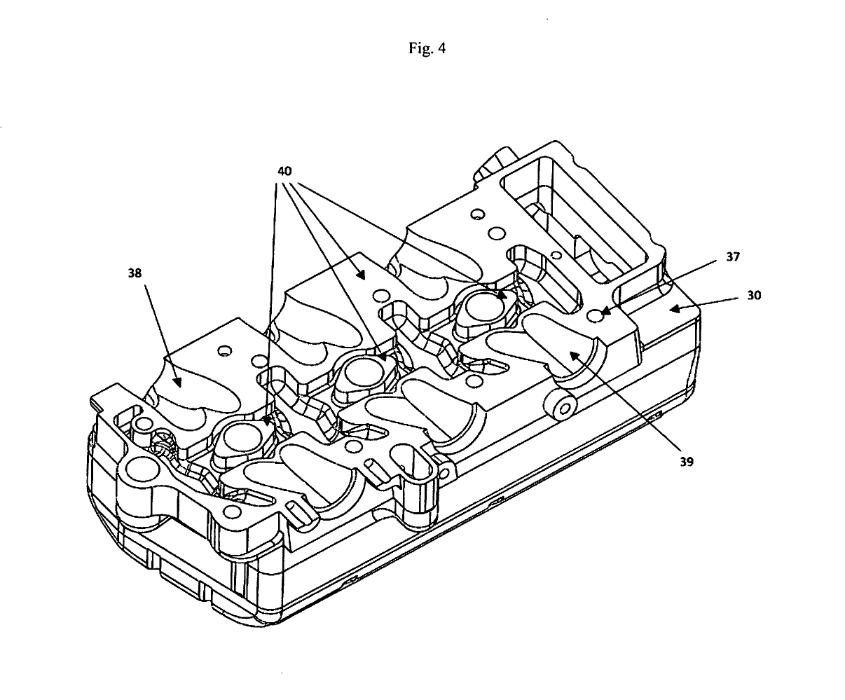

FIGS. 3-6 illustrate cylinder head 10 of FIG. 2 following the successive removal of each one of the layers that together form cylinder head 10. For example, deck plate 20, visible in FIG. 2, is removed in FIG. 3 to illustrate the surface features of first port layer 25. Surface features of first port layer 25 visible in FIG. 3 include brazing surfaces 27. As mentioned above, in a step of the method of manufacture of cylinder head 10, prior to stacking and brazing, a brazing material (not pictured) will be applied to brazing surfaces 27. Also visible in FIG. 3 are primary coolant passages 34. Ports 29 within the bottom 19 are visible remain visible FIG. 3, with the top of port 29 defined in first port layer 25, and the bottom face of port 29 defined by second port layer 30. The surfaces of each of the subsequent layers are visible in FIGS. 4-6.

FIG. 4 illustrates a view similar to that of FIG. 3, though first port layer 25, shown in FIG. 3, has been removed in FIG. 4, revealing the surface of second port layer 30. Similar to first port layer 25, second port layer 30 includes numerous brazing surfaces 40. Following machining and prior to stacking, a brazing filler material will be applied to brazing surfaces 40 as described in more detail below. Also visible in FIG. 4 are imbedded holes 37, etc. The “bottom halves” the walls of both the intake port 38 and exhaust port 39 are visible in FIG. 4.

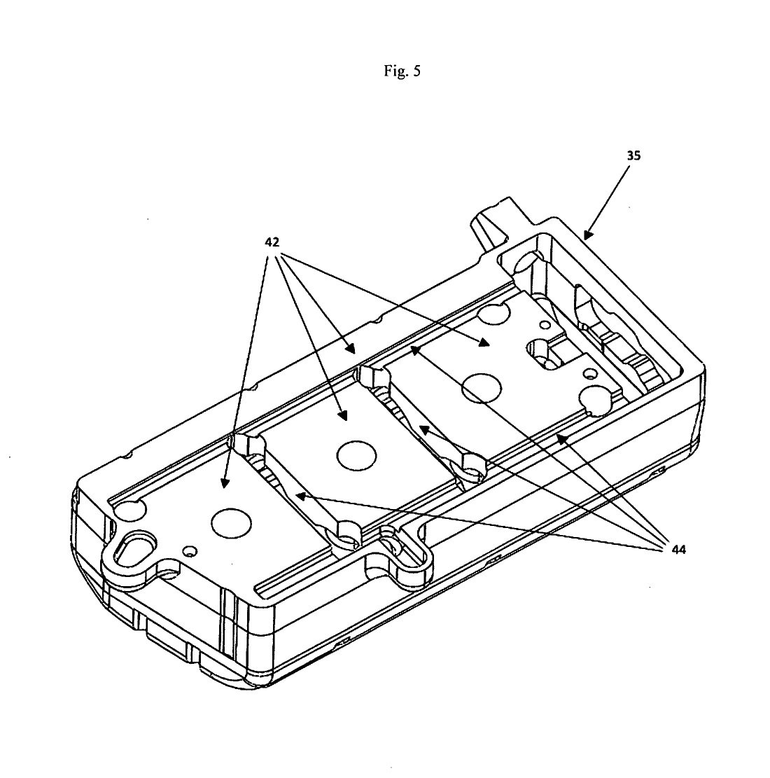

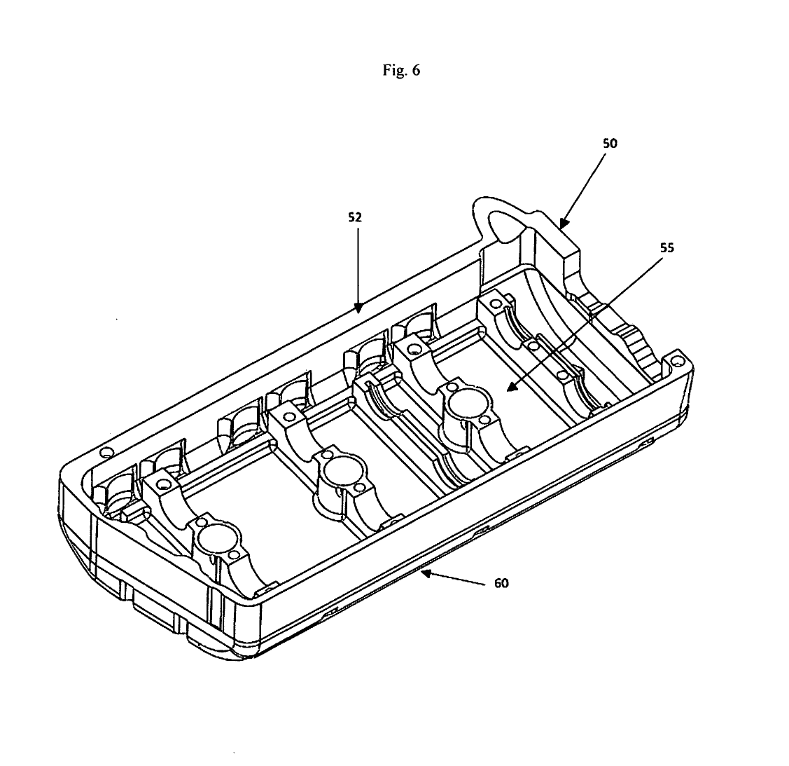

FIG. 5 is similar to FIG. 4, except that second port layer 30, which is most visible in FIG. 4, has been removed in the illustration of FIG. 5. Brazing surfaces 42 of first cam journal layer 35 are visible in FIG. 5. Also visible are low pressure oil return passages 44. And finally, cam journal layer 35 of FIGS. 1-5 is removed in the illustration of FIG. 6. Brazed surfaces 52 are exposed in FIG. 6. Cam journal cap 55 is visible in FIG. 6, as it is disposed within second cam journal layer 50 and valve cover 60. Though a cylinder head according to the invention may have a lesser number or a greater number of layers, and though a cylinder head according to the invention may be either conventional or custom, the foregoing features highlight the structure of cylinder head 10.

Returning now to the initial design of cylinder head 10 according to the invention, CAD/CAM or comparable software, which is broadly commercially available, is consulted or employed to design the features of the desired cylinder head. As a preliminary step in the production of cylinder head 10, a design is prepared with the objective of the particular performance and other requirements utilizing three-dimensional CAD/CAM software. Depending upon these particular requirements, the particular structure of the cylinder head is designed. Particular attention is given to the structure and location of imbedded holes, passages and chambers, such as combustion chamber valve ports, exhaust manifold ports, coolant passages, and the like. Intake and exhaust ports, coolant passages, oil chambers and vapor passageways, dimensions of the combustion chambers, and all other design parameters are incorporated into the three dimensional design of the cylinder head. Other considerations such as minimizing wall thicknesses between chambers, and others can also be accommodated in the design. Refined, detailed features are then added to the basic design. Additional elements such as, for example fins, small ports and passages, and other structural elements, could also be incorporated, though they are not included in cylinder head 10.

Whether otherwise conventional or highly custom, parting lines are then incorporated into the final design of the cylinder head. The parting lines are preferably horizontal to facilitate the brazing process, but other orientations are possible. Examples of parting lines are discussed above. The parting lines delineate surface finishes that will serve as brazing surfaces upon separate plates. The surface finishes will be machined onto the plates when they are later machined using the design. Any surface finish specifications may also be specified in the design.

As a further step in the design process, locating or alignment features may be added, in order to achieve accurate layer alignment prior to brazing. Examples of alignment features are illustrated in FIG. 2A above. Further design refinement steps may include, for example, removing unnecessary material for weight for reduction. This and other refinements are elective by the designer and/or customer. And among final design refinements is a step to calculate “tolerance error” that may result or “stack up” between brazed layers. The designer can compensate for any such error if necessary. In addition, desired surface finishes should be identified, including those surfaces that will be brazed. As discussed in more detail below, particular surface finishes may be more desirable than others for enhancing capillary action, for example.

Following initial design of the cylinder head and separation of the design into layers, the design may be machined onto metal parts. Generally speaking, we use the term machining herein to refer to a process by which material is removed from a billet or a blank of material, according to a pattern, in order to impart features upon the billet or blank. There are many types of CNC machining known, including but not limited to turning, grinding, milling, etc. For further reference to the options available for CNC machining, see CNC Programming Handbook: A comprehensive guide to practical CNC programming, Smid, Peter, ISBN: 9780831133474 (2007). Following CNC machining of the metal plates, a tolerance check of machined parts is recommended. Additional surface finish operations may be desired, as is a test fit of the assembly.

Numerous methods of brazing are known in the art, and one may be more suitable than another depending upon the end result desired. In addition, different base metals dictate different process and material details. (See, Brazing Handbook, American Welding Society, ISBN: 0-8 17 1-359-4; Brazing, Schwarz, Mel, ISBN-10: 0871707845; ISBN-13: 978-0871707840 (2003); Industrial Brazing Practice, Roberts, Philip, ISBN-10: 0849321123; ISBN-13,978-0849321122 (2003).

As a preliminary step, a suitable base material and target filler brazing materials for the particular engine must be identified. Numerous base metals including but not limited to 6061-T6 aluminum and 7005 aluminum alloy are available and can be obtained from California Metal Supply, Inc. Suitable brazing filler material for use with the aluminum base include but is not limited to BAl—SiN brazing material, where B represents brazing material, Al=aluminum, Si=silicon, and N=a numeral between 1 and any numeral representing the current number industry standard mix of Al and Si, and possibly additional components. (For example, N may be 2, 3, 4, etc., and the resulting material represented as BAl—Si2, BAl—Si3, etc). Additional desirable brazing filler materials include Copper, Magnesium and Tin. An example of a desirable filler material can be represented by the formula Al-9.6Si-20Cu, where the numerals represent percentages of the element adjacent the respective numeral. As brazing techniques develop, other materials may be suitable according to the invention.

Next, preparation of surfaces for brazing is desirable. Preparation may include degreasing, cleaning and imparting a desired surface roughness. Brazing material may be applied to surfaces in sheets, preformed shapes, creams, powders, and other forms. Alignment pins and/or sleeve(s) may be inserted to secure the position of the plates to be joined. In addition, or in the alternative, alignment features may be directly machined into the parts to be brazed.

Among brazing techniques available are dip brazing, torch brazing, and other methods. Brazing of components having hidden voids is preferably performed in a vacuum furnace, though alternatively can be performed in an inert gas furnace, or other suitable brazing apparatus. The temperature of the oven is preferably higher than the solidus temperature of the brazing filler material but lower than the solidus temperature of the base material. The assembly may then be heat treated as required (for example to a T6 temper for certain aluminum alloys). The assembly should be inspected following heat treatment. Surfaces should be cleaned and treated as needed.

Some features may be machined post brazing. Following machining, check tolerances and assemble additional parts as required. Some post-brazing machining may be desired, identified and tested as necessary. Post-brazing machining features can be incorporated into the primary design as needed. Stress analysis of the brazed assembly may be performed to assure structural integrity.

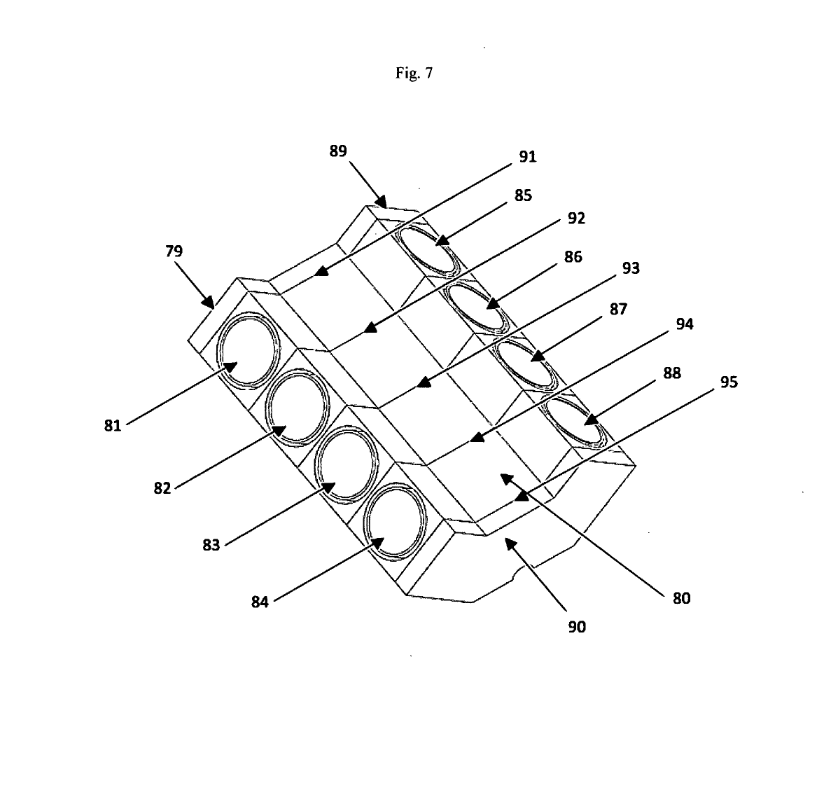

The foregoing steps can be utilized in the custom, built-to-order manufacture of many engine components. In addition to the example of an engine cylinder head, the method may also be used to design and manufacture an engine block. Using the same principles as described in detail above, engine cylinder block 80, illustrated in FIG. 7, may be made according to the invention. Engine block 80 can be characterized as a “V-8” design, but other engine designs are within the scope of the invention. Conveniently, a “V-12” or “V-24” could be designed using the same components as those used in the manufacture of engine block 80 just by increasing the number of central cylinder housing blocks. In the example of FIG. 7, engine block 80 includes cylinder bank 79. Cylinder bank 79 includes cylinder housings 81, 82, 83 and 84. Engine block 80 also includes cylinder bank 89, which holds cylinder housings 85, 86, 87 and 88.

Casing 90 of engine block 80 is adjoined to the exterior of engine block 80. Brazing joints 91, 92, 93, 94 and 95 are visible in the view of FIG. 7. Using the principles and methods described in detail above, brazing joints 91, 92, 93, 94 and 95 are formed during a brazing process.

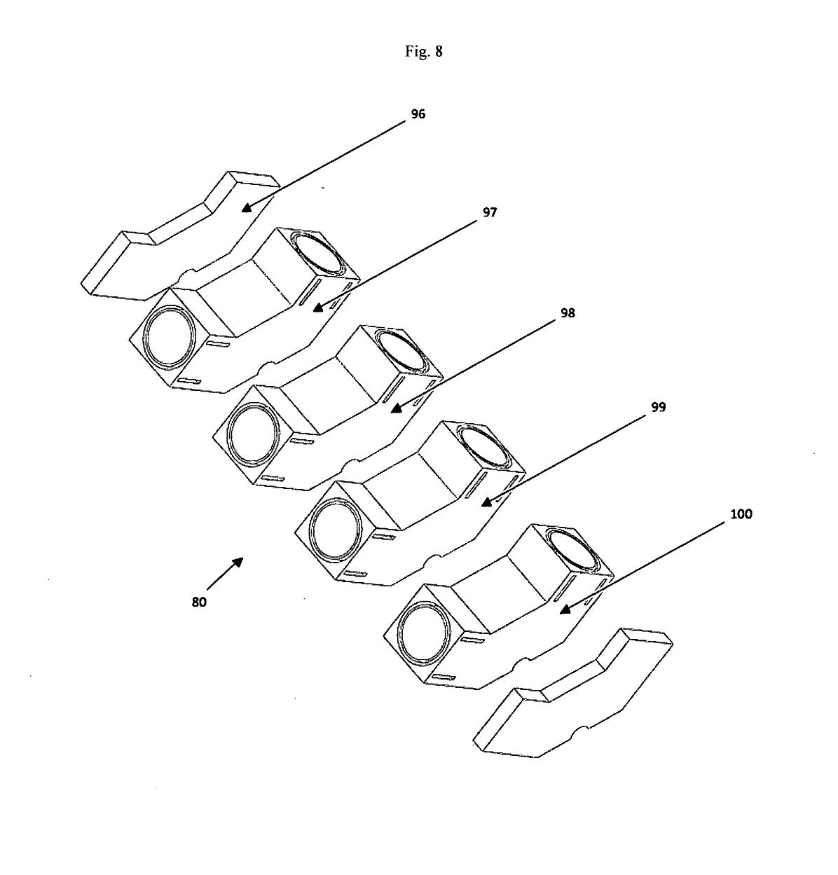

FIG. 8 represents an “exploded” view of the embodiment of FIG. 7 in order to illustrate the design of engine block 80. The particular, desirable features of an engine block are first designed using CAD/CAM software. In addition to any desired detail features, including but not limited to alignment features, parting lines are incorporated into the design. The parting lines enable the separation of the design into layers which will be machined onto blank metal components. The individual metal components will include brazing surfaces to which brazing material may be applied, as described above. Some of these brazing surfaces 96, 97, 98, 99 and 100 are visible in FIG. 8. After the individual layers have been machined and refinements made as desired, brazing material will be applied to brazing surfaces 96, 97, 98, 99 and 100. The components are then assembled or stacked and secured as desired, and the entire assembly will be placed in a vacuum furnace to form engine block 80 of FIG. 7. Brazing joints 91, 92, 93, 94 and 95 will be formed between components, and finishing steps completed.

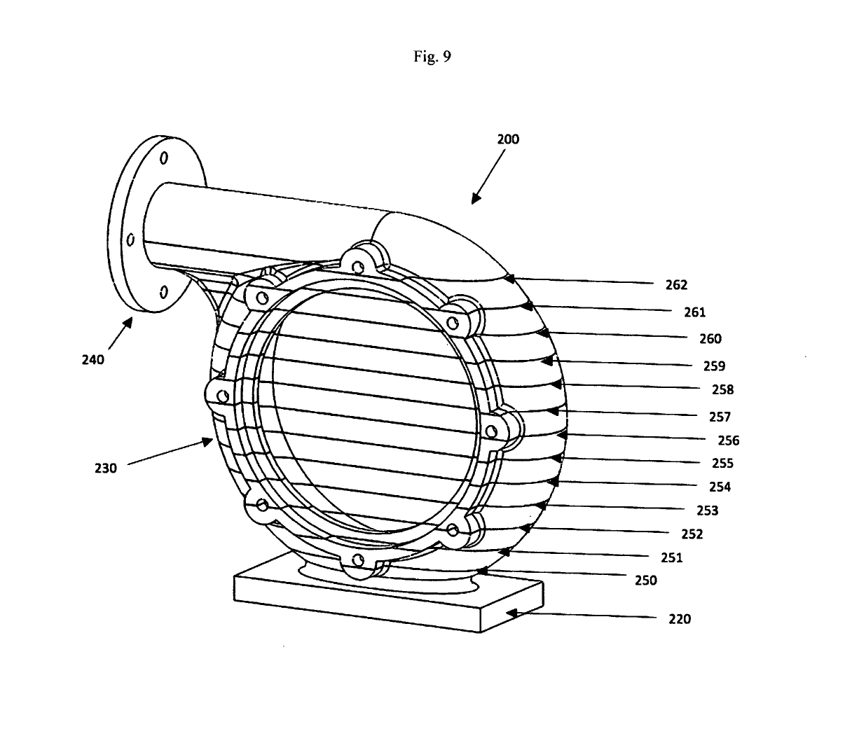

An example of a non-engine component according to the invention is illustrated in FIG. 9. Centrifugal pump housing 200 is shown in a perspective view. Pump housing 200 has mount 220, main body 230, and outlet 240.

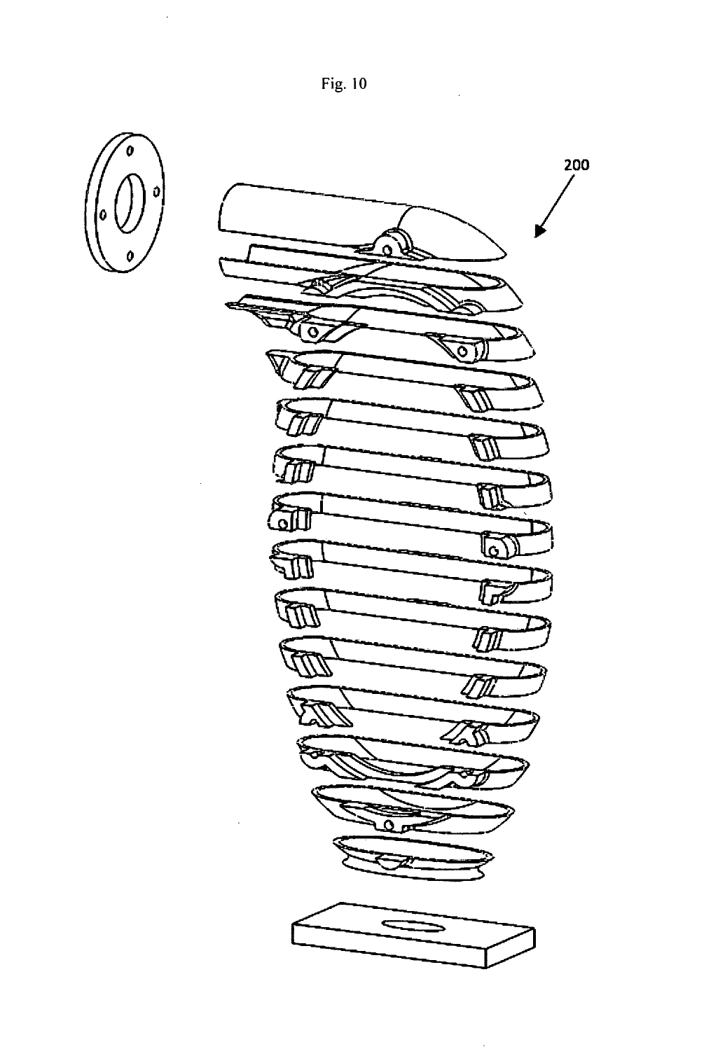

Utilizing the principles and methods described in more detail above, centrifugal pump housing 200 is designed (as conventionally or as custom as desired) using CAD/CAM software. In addition to the structural components of the design, a desired number of parting lines, in this case parting lines 250-262 are incorporated into the design. See FIG. 10. The design is machined onto separate metal blanks which are then assembled, in a manner similar to that described above and/or with some variations, and joined via a brazing process.

It should be recognized that a number of variations of the above-identified examples will be obvious to one of ordinary skill in the art in view of the foregoing description. Accordingly, the invention is not to be limited to those specific embodiments and methods of the present invention illustrated and described herein. Rather, the scope of the invention is to be defined by the claims and their equivalents.

We claim:

1. A component of a mechanical power generation and transmission apparatus, the component formed from a first part, a second part and a third part, wherein each part comprises at least one base metal, at least one machined feature, and at least one area that is suitable for brazing; the component also including a first brazed joint and a second brazed joint, wherein each part is affixed to at least one other part by at least one of the brazed joints.

2. The component according to claim 1, wherein said first brazed joint and said second brazed joint further comprise at least one brazing filler material.

3. The component according to claim 1 wherein a first part comprises a first void and a second part comprises a second void disposed in fluid communication with said first void to define at least one port.

4. The component according to claim 3 further comprising an exterior surface, wherein the at least one port is formed from a plurality of voids in a plurality of parts, wherein at least one of said voids is not accessible to machining from the exterior surface of said component.

5. The component according to claim 1, wherein at least one of said parts comprises a metal plate comprising a plurality of features, wherein said features are machined according to a predetermined design using computer numerical controlled machining.

6. The component according to claim 1, wherein said component is designed and produced according to a method using computer numerical controlled machining, wherein said method comprises steps during which a design is prepared; the design is machined onto a plurality of separate metal plates; the plates are stacked one on top of another; and the plates are joined one to another by brazing.

7. The component according to claim 1, wherein the area that is suitable for brazing is made suitable for brazing by subjecting it to one or more steps selected from the list consisting of: degreasing, cleaning, roughening.

8. The component according to claim 1, wherein the at least one base metal comprises Aluminum.

9. The component according to claim 1, wherein the method of brazing is selected from the group consisting of: gas furnace brazing, induction brazing, dip brazing, block brazing, diffusion brazing, electron beam brazing, exothermic brazing, flow brazing, infrared brazing, laser brazing, step brazing, twin carbon arc brazing, and vacuum furnace brazing.

10. The component according to claim 2, wherein the brazing filler material comprises Aluminum and Silicon.

11. The component according to claim 1, wherein the component is selected from the group consisting of: internal combustion engine; internal combustion engine cylinder head;
internal combustion engine block; transmission housing; centrifugal pump housing; engine cylinder block; monobloc; crank case; automotive power train house; and mechanical pump casing.

12. The component according to claim 1 wherein said component defines a cylinder head for an internal combustion engine and said cylinder head comprises a plurality of parts including a deck plate, a first port layer, a second port layer, a first cam journal layer, a second cam journal layer, and a valve cover.

13. The component according to claim 13 wherein said deck plate comprises an oil vapor vent, a timing chain access port, and a plurality of combustion chamber ports including at least one spark plug hole and at least one valve port.

14. The component according to claim 6 wherein said design comprises a plurality of parting lines separating the design into a plurality of layers.

15. A method of manufacture of a component for mechanical power generation and transmission, the method comprising the steps of:
creating a design of the component features using computer numerical controlled design;
machining a plurality of the component features onto three or more parts using computer numerical controlled machining;
joining the parts one to another using one or more brazing technique.

16. The method according to claim 15, wherein each part includes at least one surface that is suitable for brazing.

17. The method according to claim 16, wherein the step of brazing includes adding brazing filler material to the surfaces that are suitable for brazing.

18. The method according to claim 15, with the additional steps of forming an assembly from the parts and heating the assembly in a vacuum furnace.

19. The method according to claim 16, with the added step of preparing the brazing surfaces for brazing by performing one or more of the following steps: degreasing the part, cleaning the part, roughening the part.

20. The method according to claim 15 wherein the step of brazing includes the steps of selecting a desired brazing base material and a desired brazing filler material.

21. The method according to claim 17 wherein at least one of said parts includes a base metal.

22. The method according to claim 21 wherein said base metal comprises Aluminum.

23. The method according to claim 20 wherein said brazing filler material comprises Aluminum and Silicon.

24. The method according to claim 15 wherein the component is selected from the group consisting of: internal combustion engine; internal combustion engine cylinder head; internal combustion engine block; transmission housing; centrifugal pump housing; engine cylinder block; monobloc; crank case; automotive power train house; and mechanical pump casing.

25. The method according to claim 15 wherein said component comprises an exterior surface, said features include a plurality of voids in fluid communication with one another to define at least one port, where some of the voids are not accessible to machining from the exterior surface of the component.

26. The method according to claim 15, wherein the one or more brazing technique is selected from the group consisting of: gas furnace brazing, induction brazing, dip brazing, block brazing, diffusion brazing, electron beam brazing, exothermic brazing, flow brazing, infrared brazing, laser brazing, step brazing, twin carbon arc brazing, and vacuum furnace brazing.

27. A commercial method of producing a component for mechanical power generation and transmission according to custom order, the method including the steps of:
preparing or receiving a custom order for the component;
designing features of the component according to the order;
machining the features onto one or more parts; and
joining the parts using one or more brazing technique.

28. The method according to claim 27 wherein the component is selected from the group consisting of: engine cylinder head, engine block, transmission housing, centrifugal pump housing, engine cylinder block, engine monobloc, engine crank case, and automotive power train housing.

29. The method according to claim 27, wherein the parts include surfaces suitable for brazing.

30. The method according to claim 27, wherein the step of joining the parts using one or more brazing techniques includes the step of adding brazing filler material to the surfaces that are suitable for brazing.

31. The method according to claim 27, with the additional steps of forming an assembly from the parts and heating the assembly in a vacuum furnace.

32. The method according to claim 29, with the added step of preparing the surfaces that are suitable for brazing by performing one or more of the following steps: degreasing the surface, cleaning the surface, roughening the surface.

33. The method according to claim 27 wherein the step of joining the parts using one or more brazing techniques includes the steps of selecting a desired brazing base material and a desired brazing filler material.

34. The method according to claim 33 wherein the brazing base material comprises metal including Aluminum and the brazing filler material comprises Aluminum and Silicon.

35. The method according to claim 27 wherein said component comprises an exterior surface, said features include a plurality of voids in fluid communication with one another to define at least one port, where some of the voids are not accessible to machining from the exterior surface of the component.
